(19) United States
(12) Patent Application Publication
(10) Pub. No.: US 2009/0061275 A1
(43) Pub. Date: Mar. 5, 2009

(54) Carbonized Paper With High Strength And Its Preparation Method And Uses

(75) Inventors: Tse-Hao KO, Taichung (TW); Ching-Han Liu, Taichung (TW); Chih-Jung Hung, Taichung (TW); Yuankai Liao, Taichung (TW); Jui-Hsiang Lin, Taichung (TW); Jian-Jun Huang, Taichung (TW)

Correspondence Address: VENABLE LLP, P.O. BOX 34385, WASHINGTON, DC, 20043-9998, US

(73) Assignee: Feng Chia University, Taichung (TW)

(21) Appl. No.: 12/013,188

(22) Filed: Jan. 11, 2008

(30) Foreign Application Priority Data
Sep. 3, 2007 (TW) 096132759

(51) Int. Cl. H01M 8/10; C01B 31/02; H01M 8/00

(52) U.S. Cl. 429/30; 264/29.6; 429/34

(57) ABSTRACT

Strengthened carbonized paper, its preparation method and uses are provided. The carbonized paper comprises a mixed spun fabric containing oxidized fibers and polyamide fibers as the reinforced material. The carbonized paper has good tensile strength and electric conductivity. The carbonized paper can be used as the gas diffusion layer material in the fuel cell for better performance. Moreover, the carbonized paper of the subject invention is useful as the anti-electromagnetic material and reinforced composite material.

This application claims priority to Taiwan Patent Application No. 096132759 filed on Sep. 3, 2007.

### CROSS-REFERENCES TO RELATED APPLICATIONS

Not applicable.

### BACKGROUND OF THE INVENTION

1. Field of the Invention

The present invention provides a carbonized paper with high strength and its preparation method and uses. Particularly, the present invention provides a method for preparing carbonized paper for use as a gas diffusion layer material in a fuel cell and the carbonized paper produced thereby.

2. Descriptions of the Related Art

In recent years, the development of fuel cells equipped with a hydrogen supply system has increased due to efforts in alleviating the shortage of energy and the greenhouse effect on earth. The fuel cell does not only prevent environmental problems caused by disposable non-rechargeable batteries, but also eliminates the need of a time-consuming recharging procedure required for a conventional rechargeable battery. Furthermore, the emission of the fuel cell (e.g., water) is harmless to the environment.

Among various fuel cells, proton exchange membrane fuel cells (PEMFCs) and direct methanol fuel cells (DMFCs), which can operate at low temperature and output a high current density, are widely used. For example, PEMFCs are applied to various driving systems, such as motor vehicles, ships and aircrafts. PEMFCs may also be employed as power supplies of combined power generation systems in households, hospitals and office buildings. As for DMFCs, they feature a simple structure, a high volumetric energy density, a short startup time and convenient fuel replenishment, and thus, are especially useful in various mobile or portable driving sources.

In the PEMFC, each of its individual cells has a membrane-electrode assembly (MEA) and bipolar plates with a gas flow channel. The MEA typically consists of a proton exchange membrane (generally made of a polymer membrane, for use as an electrolyte), two catalyst layers on both sides of the proton exchange membrane, and two gas diffusion layers (also known as “electrode gas diffusion layers”) disposed on the outside surfaces of the two catalyst layers. The catalyst may be coated directly on both sides of the proton exchange membrane to form a catalyst coated proton exchange membrane, which is coated with a gas diffusion layer respectively on each side thereof. Alternatively, the catalyst may be coated on the two gas diffusion layers. The proton exchange membrane is then interposed between the two catalyst coated gas diffusion layers, thus forming an MEA. Then, the MEA is sandwiched between the two bipolar plates (typically made of a graphite material), and the resulting assembly is encapsulated to complete the PEMFC.

The PEMFC generally operates in the following mechanism. Hydrogen, serving as the fuel, passes through the gas diffusion layer to enter the anode catalyst, where it is catalyzed to generate hydrogen ions and electrons. The electrons are conducted through the anode to an external circuit to form a current, while the hydrogen ions migrate to the cathode catalyst through the proton exchange membrane. Oxygen fed through the other gas diffusion layer will then react with the hydrogen ions and the electrons transferred from the external circuit to produce water. The resulting water will be directly vented out to the exterior environment.

It can be seen from the above description that the gas diffusion layer mainly serves two functions. Firstly, the porous nature of the gas diffusion layer allows the reactant gases to smoothly diffuse into and homogeneously distribute onto the catalyst layers to create the maximum area for the electrochemical reaction. Secondly, it serves to conduct the electrons generated in the anode catalytic reaction from the anode catalyst layer to the external circuit and then from the external circuit to the cathode catalyst layer. In respect of this, the gas diffusion layer must be made of a porous material and have good conductivity. Furthermore, to prevent the water molecules in the pores of the gas diffusion layer to obstruct the transferring of the reactant gases, the gas diffusion layer typically must be subjected to a hydrophobic treatment in advance so that the reactant gases and necessary water molecules can reach the catalyst layers.

Currently, there are two kinds of gas diffusion layers, one of which is the carbon cloth, and the other is the carbon paper. The carbon papers currently used for the gas diffusion layers of fuel cells are mostly manufactured by a wet paper-making process, such as that disclosed in U.S. Pat. No. 6,713,034. Generally, in a wet paper-making process, carbon fibers or graphite fibers with a fiber length of about 0.5 mm to 5 mm are first mixed with wood pulp, cellulose fibers or polyethylene fibers to produce the pulp. Subsequently, the pulp is subjected to a sequence of procedures such as pressurizing and drying through a method such as JIS P-209, thereby to obtain a piece of paper containing carbon fibers. Afterwards, the piece of paper is immersed into resin, and then undergoes a sequence of processing steps such as hot pressing and carbonizing steps to eventually obtain carbon paper. However, in such a paper-making method, to homogeneously distribute the carbon fibers in paper-like form, it is necessary to use a large amount of non-conductive materials (e.g., wood pulps, cellulose fibers or polyethylene fibers), thereby, increasing the resistivity of the carbon paper. Furthermore, the resulting carbon paper has a poor tensile strength. Nonetheless, during the process of assembling the fuel cell banks (e.g., comprising 2 to 100 cells), a gas diffusion material with a high tensile strength is helpful for the assembly process.

In view of this, the present inventors have found through research that doping polyamide fibers into oxidized fibers to produce a mixed spun fabric is useful to provide a carbonized paper with high strength and superior conductivity. Particularly, when the resulting carbonized paper is used as the gas diffusion layer of a fuel cell, the fuel cell exhibits a high power density and a high current density.

### SUMMARY OF THE INVENTION

One objective of the present invention is to provide a method for preparing a carbonized paper with high strength, comprising the following steps: providing a mixed spun fabric containing oxidized fibers and polyamide fibers, wherein the amount of the polyamide fibers ranges from about 1 wt % to about 90 wt % based on the total weight of fibers; thermally treating the mixed spun fabric under the protection of an inert gas at a temperature ranging from about 400° C. to about 2500° C. for about 5 minutes to about 120 hours; immersing the thermally treated fabric in a resin; hot pressing the immersed fabric to obtain a fabric-reinforced paper; and carbonizing the fabric-reinforced paper.

Another objective of the present invention is to provide a carbonized paper with high strength, which is prepared using the method described above.

Yet a further objective of the present invention is to provide a fuel cell comprising an anode and a cathode, wherein at least one of the anode and the cathode comprises the carbonized paper with high strength of the present invention.

The detailed technology and preferred embodiments implemented for the present invention are described in the following paragraphs accompanying the appended drawings for people skilled in this field to well appreciate the features of the claimed invention.

### BRIEF DESCRIPTION OF THE DRAWINGS

FIG. 1 is a flow diagram illustrating the method for preparing carbonized paper in accordance with the present invention;

FIG. 2 is a photograph of carbonized paper of the present invention; and

FIG. 3 shows a comparison between a fuel cell comprising carbonized paper of the present invention and a prior art fuel cell.

### DESCRIPTION OF THE PREFERRED EMBODIMENT

The method for preparing a carbonized paper with high strength in accordance with the present invention comprises the following steps:

(a) providing a mixed spun fabric containing oxidized fibers and polyamide fibers, wherein the amount of the polyamide fibers ranges from about 1 wt % to about 90 wt % based on the total weight of fibers;

(b) thermally treating the mixed spun fabric under the protection of an inert gas at a temperature ranging from about 400° C. to about 2500° C. for about 5 minutes to about 120 hours;

(c) immersing the thermally treated fabric in a resin;

(d) hot pressing the immersed fabric to obtain a fabric-reinforced paper; and

(e) carbonizing the fabric-reinforced paper.

In accordance with the present invention, to prevent the fibers from being ashed during the heat treatment process, the heat treatment step is preferably carried out under the protection of an inert gas. For example, the inert gas may be selected from a group consisting of nitrogen, helium, argon, and combinations thereof. In the thermal treatment step, the shrinkage or elongation of the mixed spun fabric may be further controlled to adjust the gas permeability or strength of the resulting carbonized fabric. Such control may be accomplished by adjusting the speeds at which the mixed spun fabric is supplied into a high-temperature furnace (for heat treatment) and delivered out therefrom. Specifically, when the mixed spun fabric is delivered out of the furnace at a speed slower than the supplying speed, the mixed spun fabric will shrink, which may avoid an excessively high gas permeability in the resulting carbonized fabric. On the other hand, when the mixed spun fabric is delivered from the furnace at a speed faster than the supplying speed, the mixed spun fabric will be elongated, thereby, improving the strength of the resulting carbonized fabric, which is useful as the reinforced material. Generally, if shrinkage is desired, it should be controlled at about 40%, preferably at about 25%. If elongation is desired, it should be controlled at about 25%.

The thermal treatment step of the present invention may be carried out in two stages, i.e., a two-stage heat treatment. It comprises a first thermal treatment stage and a second thermal treatment stage. The first thermal treatment stage is performed at a temperature ranging from about 400° C. to about 1000° C. for about 5 minutes to about 120 hours, while the second thermal treatment stage is performed at a temperature ranging from about 1000° C. to about 2500° C. for also about 5 minutes to about 120 hours. When such a two-stage heat treatment is employed, the shrinkage or elongation of the mixed spun fabric is typically controlled during the first thermal treatment stage.

The mixed spun fabric employed in the present invention comprises oxidized fibers and polyamide fibers, wherein based on the total weight of fibers, the amount of the polyamide fibers ranges from about 1 wt % to about 90 wt %, preferably from about 5 wt % to about 50%, and more preferably from about 10 wt % to about 40%. It has been found that the polyarnide fibers form a carbonized material with a high conductivity after the above thermal treatment. Therefore, without being bounded by the theory, it is believed that the higher the content of the polyarnide fibers, the higher the conductivity of the resulting mixed spun fabric. The mixed spun fabric with higher conductivity is favored as the gas diffusion layer material.

The polyamide fibers employed in the method of the present invention may comprise any suitable polyamide fibers. For example, the aromatic polyamide fibers may be used, examples of which include the commercially available products such as Normex or Kevlar from Du Pont, Technora from Teijin Corp., and Twaron from Teijin Twaron Company.

Any suitable oxidized fibers may be utilized in the present invention. In general, the oxidized fibers may be prepared by thermally treating fibers selected from a group consisting of polyacrylonitrile (PAN) fibers, asphalt fibers, phenolic resin fibers, cellulose fibers, and combinations thereof. For example, the oxidized fibers of the subject invention may be prepared by thermally treating a PAN fiber at a temperature ranging from about 200° C. to about 300° C. in air. Commercially available flame retardant fibers may also be directly used as the oxidized fibers in the method of the present invention, for example, Panox from SGL Carbon Group, Pyromex from Toho Tenax, Pyron from Zoltek, Lastan from Asahi Kasei or the like. These flame retardant fibers have a diameter of no less than about 13 μm, a density of no less than about 1.35 g/cm³, and a limiting oxygen index (LOI) of no less than about 40%.

In accordance with the present invention, the mixed spun fabric may be prepared by the following steps:

(i) mixing the oxidized fibers and the polyamide fibers to provide a fiber mixture;

(ii) spinning the fiber mixture to provide a mixed spun yarn; and

(iii) weaving the mixed spun yarn to provide the mixed spun fabric.

For example, in the mixing step, the oxidized fibers and polyamide fibers with a length of about 0.5 cm to about 30 cm (preferably about 1 cm to about 20 cm) may be put into a spun machine for uniform dispersion in a predetermined weight ratio to obtain a uniformly mixed fiber mixture. The amount and species of the oxidized fibers and polyamide fibers are all as described above, and will not be described in detail herein again.

Subsequently, the resulting fiber mixture is spun. This spinning process may be done in a single step or two steps (a roving spinning step followed by a fine spinning step.) In the latter, the fiber mixture is drafted about 3 to about 10 times to prepare a roving yarn, and then, the roving yarn is drafted about 8 to about 15 times to obtain a spun yarn, thus, providing a desired mixed spun yarn. Thereafter, the spun yarns are optionally processed for doubling two strands of the spun yarns to provide double-strand mixed spun yarns.

Then, the mixed spun yarn is weaved by any suitable weaving technology, such as tatting, knitting or a combination thereof, to provide the mixed spun fabric. If tatting is used, a mixed spun fabric with a plain weave or a twill weave can be provided. If a knitting manner is used, a mixed spun fabric with a knitted structure may be provided. The mixed spun fabric generally has a thickness of about 0.1 mm to about 1 mm, a specific weight of about 50 g/m² to about 500 g/m², and a yarn density of about 10 yarns/inch to about 100 yarns/inch.

The mixed spun fabric used in the method of the present invention may also be a mixed spun felt prepared by needling a fiber mixture comprising oxidized fibers and polyamide fibers, which may be accomplished by a needling machine. The mixed spun felt prepared in this way generally has a thickness of about 0.1 mm to about 2 mm and a specific weight of about 40 g/m² to about 500 g/m².

In accordance with the present invention, subsequent to the thermal treatment step, the thermally treated fabric is immersed into resin. The resin used in the immersing step may be thermosetting resin, thermoplastic resin, or a combination thereof. Preferably, the resin should have fluidity at room temperature (for convenience of performing the immersing step) and is still conductive after being carbonized (to not affect the conductivity of the carbonized paper). For example, the resin for immersing the fiber fabric may include, but is not limited to, phenolic resin, furan resin, polyamide resin, polyimide resin, or a combination thereof. The phenolic resin is preferred. The immersing step allows the immersed fabric to comprise, based on the total weight of the fabric, about 0.01 wt % to about 40 wt % of resin, and preferably about 0.01 wt % to about 20 wt % of resin.

The immersing step described above may be carried out using any suitable means. For example, it can be accomplished with the assistance of a squeezing apparatus. More specifically, the thermally treated fabric is immersed into resin, and then, the immersed fabric is squeezed by the squeezing apparatus, so that the resin is distributed uniformly within the fabric fibers. Moreover, by adjusting the rollers of the squeezing apparatus, the applied amount of resin may be controlled.

Subsequently, the immersed fabric is hot pressed to cure the resin to obtain fabric-reinforced paper. In accordance with the subject invention, the hot pressing step is generally carried out at a temperature ranging from about 50° C. to about 320° C. and a pressure ranging from about 1 kg/cm² to about 200 kg/cm^{2.} The preferred temperature ranges from about 60° C. to about 150° C, while the preferred pressure ranges from about 5 kg/cm² to about 50 kg/cm². The resulting reinforced paper in the hot pressing step typically has a thickness of about 0.05 mm to about 0.7 mm.

Additionally, subsequent to the immersing step and prior to the hot pressing step, the immersed fabric may be optionally dried. Drying is generally carried out at a temperature ranging from about 60° C. to about 120° C. and may be accompanied optionally by ventilation.

Finally, the fabric-reinforced paper is carbonized to provide carbonized paper. In accordance with the present invention, the carbonizing step is carried out at a temperature ranging from about 1000° C. to about 3000° C. for about 2 minutes to about 48 hours. In one embodiment of the present invention, to prevent the fabric-reinforced paper from being ashed during the heat treatment process, the carbonizing step is carried out in a vacuum or in the presence of an inert gas. For example (but not limited thereto), the carbonizing step may be carried out in an atmosphere selected from a group consisting of nitrogen, helium, argon, and combinations thereof.

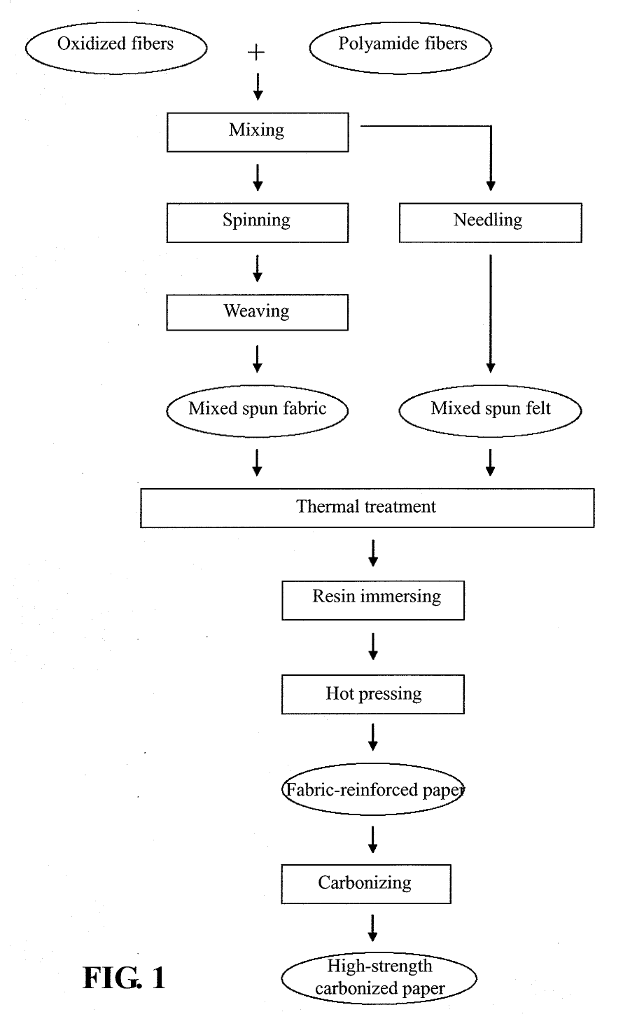

FIG. 1 depicts an operational flow diagram of a method for preparing carbonized paper in accordance with the present invention. Initially, a homogeneous mixture of oxidized fibers and polyamide fibers is spun and weaved to obtain a mixed spun fabric, or is needled to obtain a mixed spun felt. Afterwards, the resulting mixed spun fabric or felt is subjected to a thermal treatment, and the thermally treated fabric is then immersed into a resin. Subsequently, the immersed fabric is hot pressed to obtain fabric-reinforced paper, which is finally carbonized to obtain the final carbonized paper with high strength.

The carbonized paper prepared using the above method has a high strength, and when applied as the gas diffusion layer in the electrode of a fuel cell, may provide a superior cell performance (e.g., high power density and high current density) for the fuel cell.

Therefore, the present invention further relates to carbonized paper with high strength, which is prepared by the method described above. In addition to its use in a fuel cell, the carbonized paper may also be used as an anti-electromagnetic material and a reinforced composite material.

The carbonized paper of the present invention generally has a thickness of about 0.02 mm to about 0.7 mm, a specific weight of about 20 g/m² to about 250 g/m², a penetration resistance of no more than about 950 mΩ and a sheet resistance of no more than about 1.0 Ω/sq. The penetration resistance (resistance in the thickness dimension) of the carbonized paper should be no more than about 700 mΩ, while the surface resistance is no more than about 0.8 Ω/sq. As described above, in the present invention, the oxidized fibers and polyamide fibers are mixed and then thermally treated to provide a fabric-reinforced material used in the carbonized paper of the present invention. As shown in the following examples, as compared with the prior art, the carbonized paper of the present invention features a lower penetration resistance, i.e., a higher conductivity, and demonstrates a better cell performance (e.g., current density and power density) in a test performed on an individual cell of a fuel cell. Additionally, as compared with carbonized paper prepared by the wet paper-making method, the fabric-reinforced material contained in the carbonized paper of the present invention has a more uniform pore distribution, which may allow more uniform gas diffusion and ensure a better performance of the fuel cell.

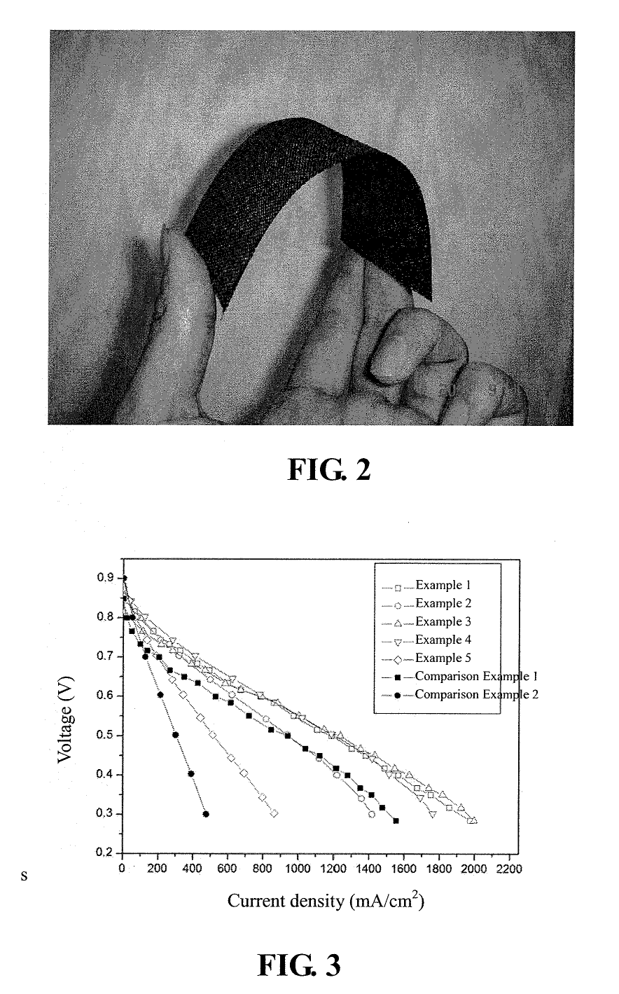

Furthermore, the carbonized paper of the present invention has a tensile strength of no less than about 0.35 MPa, and preferably no less than about 0.45 MPa. It would be best if the tensile strength is no less than about 1 MPa. This may compensate for the shortcoming of poor tensile strength of the carbonized paper prepared by the conventional wet paper-making method. Meanwhile, as shown in FIG. 2, the carbonized paper of the present invention has a high flexibility, which represents an improvement to the brittle nature of the conventional carbonized paper and is advantageous for the assembly of the cell module.

The present invention further relates to a fuel cell, which is characterized by that at least one of the anode and the cathode comprises the carbonized paper with high strength of the present invention. Preferably, both the anode and the cathode thereof should comprise the carbonized paper with high strength of the present invention.

Briefly speaking, the fuel cell according to the present invention primarily comprises an anode gas diffusion layer, a cathode gas diffusion layer, and an electrolyte sandwiched therebetween. The fuel cell further comprises an anode catalyst sandwiched between the anode gas diffusion layer and the electrolyte, and a cathode catalyst sandwiched between the cathode gas diffusion layer and the electrolyte to catalyze reactions for supplying electric power. As described above in the “Description of the Related Art,” the material and structure of various components in the fuel cell are well known to those having ordinary skill in the art. For example, Taiwan Patent Publication No. 1272739 and U.S. Patent Publication No. 2007/0117005A1 are incorporated herein for reference.

The embodiments of the fuel cell of the present invention include a proton exchange membrane fuel cell (PEMFC) and a direct methanol fuel cell (DMFC). For example, the PEMFC comprises an anode gas diffusion layer and/or a cathode gas diffusion layer comprised of the carbonized paper of the present invention, a polymer proton exchange membrane (e.g., the Nafion series from Du Pont) used as the electrolyte, and a noble metal catalyst layer (e.g., Pd or Pt catalyst). Alternatively, a proton exchange membrane (e.g., a product sold by Gore Corp., U.S.A, Model: 5621 MESGA) coated with a catalyst may be used directly in conjunction with the carbonized paper of the present invention to provide a PEMFC.

As manifested by the performance test results illustrated in the following examples, the fuel cell comprising the carbonized paper of the present invention exhibits a high power density and a high current density.

The following examples will be hereby described to further illustrate the present invention. The measurement instruments and method adopted are described as follows:

### (A) Measurement Method of Gas Permeability

Measurement instrument: Gurley Model 4320, U.S.A

Measurement specifications: ASTM D726-58

Capacity of the barrel for gas permeability measurement: 300 cc

Weight of the barrel for gas permeability measurement: 5 oz

Area measured: 1 sq. in

A sample was put into a bracket of the measurement instrument, and the software was operated according to the standard procedure stated in ASTM D726-58.

### (B) Measurement Method of Cell Performance

Testing machine: FCED® PD50 Asia Fuel Cell Technologies, Ltd.

Model of the cell load: Chroma 63103

Test conditions:
Anode fuel: hydrogen (99.999%) at a flow rate of 200 c.c./min
Cathode fuel: oxygen (industrial level) at a flow rate of 200 c.c./min
Humidified temperature of the anode/cathode: 40° C.
Relative humidity at the humidifier outlet: 90%
Testing temperature: 40° C.
Assembling torque of the cell: 40 kgf·cm
Cell reaction area: 25 cm²

The sample piece was cut into a size of 5 cm×5 cm, and was assembled with a catalyst-coated membrane (manufactured by Gore Corp., U.S.A, Model: PRIMEA® Series 5621 MESGA, 35 μm in thickness and made of 45 Pt alloy/60 Pt) by a 40 kgf·cm assembling torque. The bipolar plate is a graphite plate with gate-type channels thereon. Finally, a stainless steel plate and a Teflon gasket were utilized to encapsulate a single cell for testing.

### (C) Measurement Method of Penetration Resistance

Test standard: ASTM-D 6120

A real densimeter was utilized to obtain the real volume (Vᵣₑₐₗ) of a sample piece, which was divided by the thickness of the sample piece to calculate the real area (Aᵣₑₐₗ) per cm² under a pressure of 1 bar. The sample piece was clipped by two copper pieces, with an ultimate loading pressure of 1 bar set on the strength tester. Then, an ohmmeter was connected to read the resistance under a pressure of 1 bar, and the resistivity was calculated according to the following formula:

Resistance (Ω)=resistivity (ρ)×thickness/Aᵣₑₐₗ

### (D) Measurement Method of Tensile Strength Test

Test standard: ASTM-D790

Test instrument: a universal tester manufactured by Jun Yen Precision Machinery Works (Model: CY-6040A8)

Test conditions: with a span of 10 mm, the chuck moving at a speed of 2 mm/min

Flexural or bending strength:

$${σ}_{b} = \frac{3 {P}_{max} L}{2 {bt}^{2}}$$

Flexure or bending modulus:

$${E}_{b} = ( \frac{{L}^{3}}{4 {bt}^{3}} ) ( \frac{P}{δ} )$$

P/δ: the initial slope of the S-S curve

Pₘₐₓ: the maximum load (kg)

L: span

b: width of the sample piece

t: thickness of the sample piece

### (E) Test Method of Surface Resistance

Testing machine: Loresta GP Model MCP-T600, Mitubishi Chemical Corp.

The sample piece was cut into a size of 5 cm×5 cm, and the test was performed according to JIS K 7194.

### EXAMPLE 1

Pyron manufactured by Zoltek Companies, Inc. was adopted as the oxidized fibers and Twaron manufactured by Teijin Twaron Company was adopted as the polyamide fibers, both of which had a fiber length of 5 cm.

60 wt % of the oxidized fibers and 40 wt % of the polyarnide fibers were mixed homogeneously and needled to obtain a mixed spun felt with a thickness of 0.79 mm and a specific weight of 160 g/m².

Under the protection of nitrogen, the resulting mixed spun felt was thermally treated at a temperature of 1000° C. for 5 minutes to obtain a pre-carbonized mixed spun felt, which was then immersed into phenolic resin (manufactured by Taiwan Chang Chun Plastics Co., Ltd, Model: PF-650). Subsequently, the immersed mixed spun felt was dried at a temperature of 70° C. for 15 minutes, and then hot pressed at a temperature of 170° C. for another 15 minutes to completely cure the phenolic resin. Finally, under the protection of nitrogen, the mixed spun felt was thermally treated at a temperature of 1400° C. for 5 minutes to obtain a porous and strengthened carbonized paper with a thickness of 0.42 mm and a specific weight of 117 g/m².

The above testing methods were carried out. The resulting carbonized paper was used in the anode and cathode in the cell performance test. The properties measured are listed in Table 1, and the results of the cell performance test are shown in Table 2 and FIG. 3.

### EXAMPLE 2

The same raw materials and steps as described in Example 1 were used, except that the mixed spun felt was thermally treated at 1800° C. for 5 minutes under the protection of nitrogen gas to obtain a pre-carbonized mixed spun felt. The resulting carbonized paper had a thickness of 0.52 mm and a specific weight of 107 g/m². The above testing methods were carried out. The resulting carbonized paper was used in the anode and cathode in the cell performance test. The properties measured are listed in Table 1, and the results of the cell performance test are shown in Table 2 and FIG. 3.

### EXAMPLE 3

Pyromex manufactured by Toho Tenax Co., Ltd was adopted as the oxidized fibers and Twaron manufactured by Teijin Twaron Company was adopted as the polyamide fibers, both of which were staple fibers with a fiber length of 50 mm.

70 wt % of the oxidized fibers and 30 wt % of the polyarnide fibers were mixed homogeneously and drafted in a roving frame to form a roving yarn, which was then drafted again in a spinning frame to obtain a spun yarn. Subsequently, the spun yarns were doubled to obtain a double-strand yarn of 20/2s'.

Using the double-strand yarns as a warp yarn and a weft yarn respectively, a weaving process was performed with a warp density of 32 yarns/inch and a weft density of 26 yarns/inch respectively, thus obtaining a mixed spun fabric with a thickness of 0.57 mm and a specific weight of 250 g/m².

Under the protection of nitrogen, the resulting mixed spun fabric was at first thermally treated at a temperature of 1000° C. for 5 minutes and was controlled to achieve a 20% shrinkage to obtain a pre-carbonized mixed spun fabric. Then, the mixed spun fabric was immersed into a phenolic resin (manufactured by Taiwan Chang Chun Plastics Co., Ltd, Model: PF-650). Subsequently, the immersed mixed spun fabric was dried at a temperature of 70° C. for 15 minutes, and then hot pressed at a temperature of 170° C. for another 15 minutes to completely cure the phenolic resin. Finally, under the protection of nitrogen, the mixed spun fabric was thermally treated at a temperature of 1400° C. for 5 minutes to obtain a porous and strengthened carbonized paper with a thickness of 0.50 mm and a specific weight of 145 g/m².

The above testing methods were carried out. The resulting carbonized paper was used in the anode and cathode in the cell performance test. The properties measured are listed in Table 1, and the results of the cell performance test are shown in Table 2 and FIG. 3.

### EXAMPLE 4

The same raw materials and steps as described in Example 3 were used, except that the mixed spun fabric was thermally treated at 1800° C. for 5 minutes under the protection of nitrogen gas to obtain a pre-carbonized mixed spun fabric.

The resulting carbonized paper had a thickness of 0.54 mm and a specific weight of 144 g/m². The above testing methods were carried out. The resulting carbonized paper was used in the anode and cathode in the cell performance test. The properties measured are listed in Table 1, and the results of the cell performance test are shown in Table 2 and FIG. 3.

### EXAMPLE 5

Pyromex manufactured by Toho Tenax Co., Ltd was adopted as the oxidized fibers and Technora manufactured by Teijin Corp. was adopted as the polyamide fibers, both of which were staple fibers with a fiber length of about 50 mm.

The mixing, spinning and doubling steps in described in Example 3 were repeated to obtain a double-strand yarn of 20/2s', except that the fiber mixture was comprised of 86 wt % of the oxidized fibers and 14 wt % of the polyarnide fibers.

Using the double-strand yarns as a warp yarn and a weft yarn respectively, a plain weaving process was performed with a warp density of 27 yarns/inch and a weft density of 24 yarns/inch respectively, thus obtaining a mixed spun fabric with a thickness of 0.47 mm and a specific weight of 215 g/m².

Under the protection of nitrogen, the resulting mixed spun fabric was thermally treated at a temperature of 1800° C. for 5 minutes and was controlled to achieve 20% shrinkage to obtain a pre-carbonized mixed spun fabric. The pre-carbonized mixed spun fabric was then immersed into a phenolic resin (manufactured by Taiwan Chang Chun Plastics Co., Ltd, Model: PF-650). Subsequently, the immersed mixed spun fabric was dried at a temperature of 70° C. for 15 minutes, and then hot pressed at a temperature of 170° C. for another 15 minutes to completely cure the phenolic resin. Finally, under the protection of nitrogen gas, the mixed spun fabric was thermally treated at a temperature of 1400° C. for 5 minutes to obtain a porous and strengthened carbonized paper with a thickness of 0.39 mm and a specific weight of 121 g/m².

The above testing methods were carried out. The resulting carbonized paper was used in the anode and cathode in the cell performance test. The properties measured are listed in Table 1, and the results of the cell performance test are shown in Table 2 and FIG. 3.

### COMPARISON EXAMPLE 1

A commercial carbon paper (Model TGPH-120) from Toray Industries, INC. was used, which had a thickness of 0.37 mm and a specific weight of 171 g/m².

The above testing methods were carried out. The carbon paper was used in the anode and cathode in the cell performance test. The properties measured are listed in Table 1, and the results of the cell performance test are shown in Table 2 and FIG. 3.

### COMPARISON EXAMPLE 2

A commercial carbon paper (Model TGPH-090) from Toray Industries, INC. was used, which had a thickness of 0.28 mm and a specific weight of 162 g/m².

The above testing methods were carried out. The commercial carbon paper was used in the anode and cathode in the cell performance test. The properties measured are listed in Table 1, and the results of the cell performance test are shown in Table 2 and FIG. 3.

TABLE 1

| | Penetration | Surface | Gas | Tensile |
|---|---|---|---|---|
| | Resistance | Resistance | Permeability | Strength |
| | (mΩ) | (Ω/sq) | (cm³/cm²/s) | (MPa) |
| Example 1 | 902 | 0.72 | 93 | 0.48 |
| Example 2 | 821 | 0.72 | 155 | 0.38 |
| Example 3 | 460 | 0.56 | 82 | 1.28 |
| Example 4 | 595 | 0.74 | 42 | 1.43 |
| Example 5 | 672 | 0.89 | 116 | 0.41 |
| Comparison | 989 | 0.14 | 24 | 0.26 |
| Example 1 | | | | |
| Comparison | 1378 | 0.21 | 28 | 0.20 |
| Example 2 | | | | |

TABLE 2

| | Max. Power | Current | Current |
|---|---|---|---|
| | Density | Density at 0.5 V | Density at 0.3 V |
| | (mW/cm²) | (mA/cm²) | (mA/cm²) |
| Example 1 | 626.4 | 1189.2 | 1976.4 |
| Example 2 | 441.3 | 836.5 | 1290.2 |
| Example 3 | 651.6 | 1234.8 | 1996.8 |
| Example 4 | 626.9 | 1187.0 | 1763.1 |
| Example 5 | 281.2 | 512.3 | 864.2 |
| Comparison | 511.2 | 941.6 | 1554.0 |
| Example 1 | | | |
| Comparison | 152.0 | 298.4 | 465.8 |
| Example 2 | | | |

It can be seen from Table 1 and Table 2 that as compared with the commercial carbon paper (Comparison Examples 1 and 2), the carbonized paper of the present invention (Examples 1 to 5) exhibits a lower penetration resistance, i.e., has a better conductive performance in the thickness direction. Meanwhile, the carbonized paper of the present invention (Examples 1 to 5) demonstrates an excellent tensile strength, which is particularly advantageous for the assembly process of a cell bank.

The above examples are intended to illustrate the embodiments of the present invention and its technical features, but not to limit the scope of protection of the present invention. Any modifications that can be easily accomplished by persons skilled in the art or equivalent replacements are within the scope of the present invention. The scope of protection of the present invention should be based on the claims as appended.

1. A method for preparing a carbonized paper, comprising:
providing a mixed spun fabric containing oxidized fibers and polyamide fibers, wherein the amount of the polyamide fibers ranges from about 1 wt % to about 90 wt %, based on the total weight of fibers; and
thermally treating the mixed spun fabric under the protection of an inert gas at a temperature ranging from about 400° C. to about 2500° C. for about 5 minutes to about 120 hours;
immersing the thermally treated fabric in a resin;
hot pressing the immersed fabric to obtain a fabric-reinforced paper; and
carbonizing the fabric-reinforced paper.

2. The method according to claim 1, wherein in the thermal treatment step, the fabric is controlled to have a fiber shrinkage of no more than about 40%.

3. The method according to claim 1, wherein the inert gas is selected from a group consisting of nitrogen, helium, argon, and combinations thereof.

4. The method according to claim 1, wherein the thermal treatment step comprises a first thermal treatment stage and a second thermal treatment stage, the first thermal treatment stage is performed at a temperature ranging from about 400° C. to about 1000° C. for about 5 minutes to about 120 hours, and the second thermal treatment stage is performed at a temperature ranging from about 1000° C. to about 2500° C. for about 5 minutes to about 120 hours.

5. The method according to claim 4, wherein in the first thermal treatment stage, the fabric is controlled to have a fiber shrinkage of no more than about 40%.

6. The method according to claim 1, wherein in the mixed spun fabric, the amount of the polyamide fibers ranges from about 5 wt % to about 50 wt %, based on the total weight of fibers.

7. The method according to claim 6, wherein in the mixed spun fabric, the amount of the polyamide fibers ranges from about 10 wt % to about 40 wt %, based on the total weight of fibers.

8. The method according to claim 1, wherein the polyamide fibers comprise cyclic polyamide fibers.

9. The method according to claim 1, wherein the oxidized fibers are prepared from thermally treating polyacrylonitrile fibers.

10. The method according to claim 1, wherein the oxidized fibers and the polyamide fibers have a length of about 0.5 cm to about 30 cm.

11. The method according to claim 10, wherein the oxidized fibers and the polyamide fibers have a length of about 0.5 cm to about 20 cm.

12. The method according to claim 1, wherein the mixed spun fabric is prepared by the following steps:
mixing the oxidized fibers and the polyamide fibers to provide a fiber mixture;
spinning the fiber mixture to provide a mixed spun yarn; and
weaving the mixed spun yarn to provide the mixed spun fabric.

13. The method according to claim 1, wherein the mixed spun fabric is prepared by the following steps:
mixing the oxidized fibers and the polyamide fibers to provide a fiber mixture; and
needling the fiber mixture to provide the mixed spun fabric.

14. The method according to claim 1, wherein the immersing step allows the immersed fabric to comprise about 0.01 wt % to about 40 wt % of resin, based on the total weight of the fabric.

15. The method according to claim 1, wherein the resin is selected from a group consisting of a phenolic resin, a furan resin, a polyamide resin, a polyimide resin, and combinations thereof.

16. The method according to claim 1, after the immersing step and prior to the carbonizing step, further comprising drying the immersed fabric at a temperature ranging from about 60° C. to about 120° C.

17. The method according to claim 1, wherein the hot pressing step is carried out at a temperature ranging from about 50° C. to about 320° C. and a pressure ranging from about 1 kg/cm² to about 200 kg/cm² and the carbonizing step is carried out at a temperature ranging from about 1000° C. to about 3000° C. for about 2 minutes to about 48 hours.

18. The method according to claim 1, wherein the carbonizing step is carried out under vacuum or in the presence of an inert gas selected from a group consisting of nitrogen, helium, argon, and combinations thereof.

19. A carbonized paper with high strength, which is prepared by the method according to claim 1.

20. The carbonized paper according to claim 19, which has a tensile strength of not less than 0.35 MPa.

21. The carbonized paper according to claim 19, which is used as an anti-electromagnetic material or a reinforced composite material, or used in a gas diffusion layer material of a fuel cell.

22. A fuel cell comprising an anode and a cathode, wherein at least one of the anode and the cathode comprises the carbonized paper according to claim 19.

23. The fuel cell according to claim 22, wherein both the anode and the cathode comprise the carbonized paper.

24. The fuel cell according to claim 22, which is a proton exchange membrane fuel cell or a direct methanol fuel cell.
